(19) United States
(12) Patent Application Publication
(10) Pub. No.: US 2022/0205849 A1
(43) Pub. Date: Jun. 30, 2022

(54) DEVICE FOR SIGNALING THE STATUS OF A PRODUCT TO BE MONITORED AS OR WITH THERMAL LIFE CYCLE MODEL AND A PROCEDURE FOR IT

(71) Applicant: Brainstream GmbH, Oerlinghausen (DE)

(72) Inventor: Rupprecht GABRIEL, Oerlinghausen (DE)

(73) Assignee: Brainstream GmbH, Oerlinghausen (DE)

(21) Appl. No.: 17/144,463

(22) Filed: Jan. 8, 2021

(30) Foreign Application Priority Data
Dec. 30, 2020 (DE) 10 2020 135 157.7
Jan. 6, 2021 (DE) 10 2021 100 110.2

(51) Int. Cl. G01K 7/42; G01K 7/14

(52) U.S. Cl. CPC G01K 7/425; G01K 7/427; G01K 7/14

(57) ABSTRACT

Disclosed is a device for signaling the state of a product to be monitored (PTM) having a requirement to a temperature (Tₚ) of or at delivery and administration thereof. The device comprises, integrated in a chip, a temperature sensor and a microcomputer (μC) that can be supplied with power from a power source (3), and comprises a display unit. The microcomputer (μC) has a function that is capable of calculating a thermal model of the current state of the product to be monitored and comprises a display for displaying or signaling the state or state variables calculated in the model or variables derived therefrom as a function of state values of or in the model(s).

The invention relates to a device for signaling the state of a product to be monitored (PTM), especially a pharmaceutical product, e.g. a vaccine, a foodstuff (a biological product), and a method therefor.

There are many pharmaceuticals, e.g. a vaccine that may be stored and processed under specific thermal boundary conditions only. The challenge is double:
1. Ensuring the good delivery practice (GDP) in order to deliver the product to be monitored to the receiver in a safe condition.
2. Observing the rules of administration within the life cycle of the product subsequently thereto. These rules are dependent on time and ambient conditions.

In addition, the device/method is to prevent unnecessary waste of foodstuffs and pharmaceutical products at a too early stage. The device suggested herein is thus supposed to ensure safety and go easy on resources.

Thus, highly restrictive rules for administration have been effective so far which, on the other hand, results in the fact that batches that are actually still usable have to be destroyed at a very early stage. Solving this problem in an efficient and cost-efficient manner is a challenge that can be met by using the suggested product.

The invention assumes that the rules can be mapped by a thermal model and thus can dynamically map the life cycle of the PTM. In the case of biological products moisture and gases may also be added as input parameters. However, they can be handled by the packaging which is why the thermal boundary conditions are dealt with herein only.

Furthermore, the focus is initially on temperature, as an input parameter, only which is particularly easy to measure. The life cycle that is still possible is calculated from the measured temperature using a thermal differential equation.

The parameters of the differential equation are dependent on the product (PTM). These parameters are typically determined empirically from the delay of the transfer to the good to be monitored. The result is a delay that is, in most cases, mapped by a low pass and a nonlinear characteristic which, for example, models the phase transition from solid to liquid.

In the simplest cases, this can be omitted, if the information cannot be mapped sufficiently accurately, since it is typically more important to ensure a safe transport. Too much safety is not harmful anyway. The safety margin is determined beforehand by way of experiment.

The temperatures from the model or directly from the sensor are input into an integral model mapping the life cycle of safe usage. Thus, for example, a vaccine can be used at −70° C. for one year. The same vaccine can be used at −20° C. for two months. At +20° C., the same vaccine can be used for 6 hours only.

A thermal model of the life cycle of the PTM can be determined from these and further empirically determined parameters. In general, this model has an integral function that is formed by a deviation from the temperature that ensures safe operation for a long time. Since most biological processes are not reversible, the state must not improve when the temperature falls below the safe temperature. Thus, in this case, the input parameter of the integral life-cycle model is limited to the value of zero, i.e. cannot be negative. Prior to the integral life-cycle model, nonlinear influences can be mapped by nonlinear gain elements. The respective states can be signaled depending on the target using various threshold values of the model. The signaling can be effected directly via common display means or via remote transmission to external devices.

According to the invention, this is realized by a semiconductor including a thermal sensor, for example, a bandgap circuit, which sensor covers the entire storage area and usage area. It includes a μC in a chip that is programmed such that it signals this at essential key points. For the sake of simplification, the signaling can be effected via two or more LED displays. For example, a green flashing LED can indicate the regular transfer at delivery. In the following process chain, the monitoring prior to administration is performed using one or more LEDs. Here, process times of allowed usage can be highly variable depending on the situation. For example, it is possible that there are still only 3 hours of possible process time left after reaching room temperature. However, in the example, this time is prolonged to 12 hours in the case of intermediate storage in a cooling device. This continuous calculation of the process time is the object of the suggested device that indicates the state and thus gives an indication of the remaining useful life. In a particularly simple implementation, this can be effected by LED displays, i.e. green—everything is ok, green and red—process of vaccination starts. Red—the vaccine must not be administered anymore, since the process window and the product life cycle have ended.

However, the device can also be used for both, frozen food and products transported above the freezing point. According to the invention, a dynamic integral life-cycle model that signals the state of usability by way of status monitoring is calculated in any case. Thus, it is no longer necessary to subsequently guarantee the safe transfer of perils based on the logged temperature data, which corresponds to the state of the art.

In this way, both the GDP process of delivery (safe transfer of perils) and dynamic assistance in administration using a safe practice can be achieved. Resources are not destroyed unnecessarily and a safe technology for the life-cycle calculation is provided by the dynamic model. The beginning of the process and the start of the calculation of the dynamic life-cycle model are started when the temperature falls below a lower threshold which enables the production of the circuits beforehand in large quantities without considering times and boundary conditions. The thermal model is started when the modeling device is connected and the thermal conditions, e.g. minus 70° C., are achieved.

According to FIG. 3, the model substantially consists of 2 differential equations.

The first one maps the delayed transfer of the temperature to the good. The problem is similar as in the modeling measurement via an observer in the case of parameters that cannot be measured directly and maps the temperature transfer to the good. In FIG. 3, this is the part of the entire model (11, 12) that is described herein as a reversible model of the life-cycle calculation.

The life cycle is calculated via an integral model (14) that maps the course of the life cycle using a limitation that is asymmetrical by zero (and thus not reversible) (13) and possibly a nonlinear characteristic (15) of the temperature of the good. This means the good will not be improved by cooling but can, at most, maintain its state.

The device consists of a few parts only: A chip including an integrated temperature sensor and a programmable μC, a power source (a small button cell that is able to supply the μC and the temperature sensor with sufficient energy even at the lowest storage temperature) and the display unit which, in the simplest case, comprises two LEDs only.

In order to be usable under all thermal boundary conditions, the small electronics is varnished or encapsulated to prevent errors caused by thawing. Preferably, the chip is designed such that it can be operated at a few μA, since batteries lose their capacity, in part, to an extreme extent at highly negative temperatures, for which reason lithium primary cells having a low freezing electrolyte are to be preferred. However, a battery having a frozen electrolyte can also be used when the power consumption is extremely low.

As a matter of course, the information can be conveyed in a large variety of different ways. This can be achieved by LCD or OLED displays as well as by remote interfaces via mobile-radio devices, Bluetooth devices or the like. Herein, this is illustrated primarily in a particularly simple way that can be implemented with a few percent of the value of the PTM.

An important point is that the device is capable, depending on the temperature of the PTM, of signaling the safe transfer in the process chain of delivery (GDP) and administration and that at a reasonable price. The device is to be thermally connected to the product to be monitored, i.e. the product to be monitored and the monitoring device have the same temperature at the beginning of the process. This can be easily ensured by a storehouse or storage at a monitored temperature.

### DESCRIPTION OF THE FIGURES AS EXAMPLES OF THE INVENTION(S)

FIGS. 1 and 2:

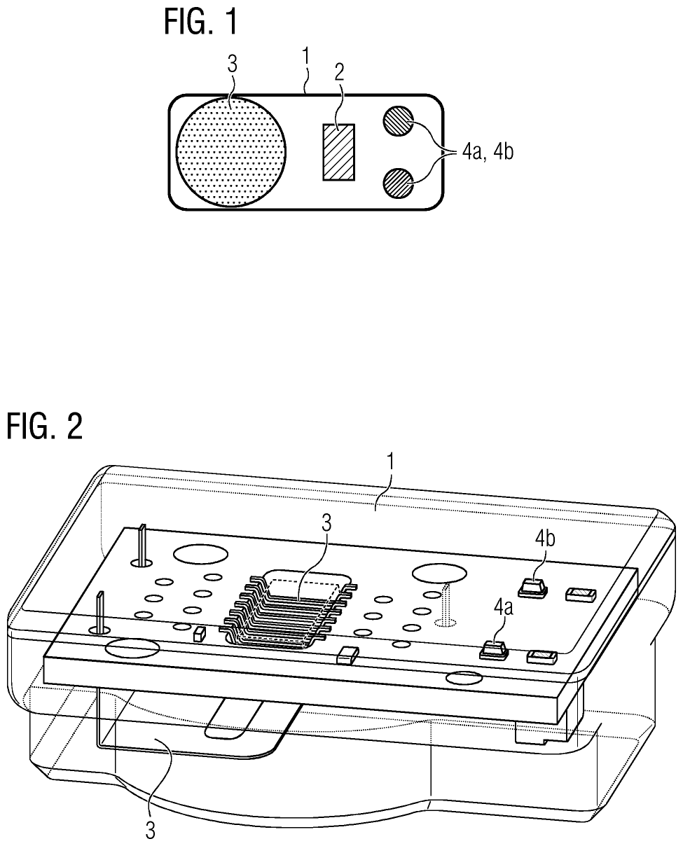

The housing 1 of the device comprising an internal electronics unit (circuit).

A chip 2 including an integrated temperature sensor and a μC for calculation of the thermal model shown in FIG. 3.

A power source 3 for supplying the circuit with power, e.g. a lithium button cell.

A display unit 4 realized by two LEDs 4a and 4b herein.

FIG. 3:

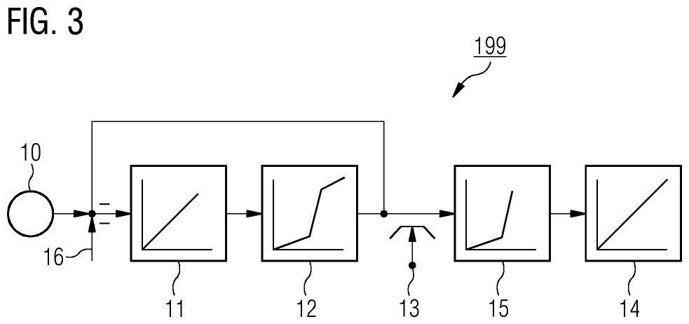

A life cycle that is still possible is calculated from the measured temperature using a thermal differential equation. FIG. 3 shows a block diagram of such a “control engine”.

A temperature sensor 10 for the temperature T_{P} of the product to be monitored (PTM; not shown here).

A delay model having functional elements 11 and 12. Thereby, the value, e.g. the difference value between the measured temperature and the real temperature of the product is formed. A nonlinear gain 12 is provided, by which phase transitions of the product to be monitored, e.g. the freezing point, are modeled. In blocks 11 and 12, the dynamics of the temperature transfer from the point of measurement to the PTM is modeled. This can be omitted when the temperature of the PTM is measured directly.

A nonlinear limitation 13 is provided as a further function, by which irreversible processes can be distinguished from reversible processes.

A further function 15 for considering nonlinear processes as a function of the temperature difference to a target value 16 is provided. The target value 16 represents the temperature at which a permanent safe storage value and transport value can be ensured.

An integrator 14 is provided that determines the allowed processing time as a function of temperature variations. The result of the integrator 14 is displayed using threshold values or starts further processes for processing the product to be monitored.

1. A device for signaling the state of a product to be monitored (PTM), such as a biological good, a pharmaceutical good, a vaccine or a foodstuff, having a requirement to a temperature (Tₚ) of or at delivery and administration thereof;
comprising an integrated temperature sensor and a microcomputer (μC) supplied with power from a power source (3), and comprising a display unit;
said microcomputer (μC) having a function that is capable of calculating a thermal model of the current state of the product to be monitored and comprising a display for displaying or signaling a state or state variables calculated in the model or variables derived therefrom as a function of state variables of or in the model(s).

2. The device according to claim 1, wherein the display is performed using LED.

2a. (canceled)

3. The device according to claim 1, wherein the state of the safe transfer of perils from a carrier to a user is indicated by a green display.

3a. (canceled)

4. The device according to claim 1, wherein usability is displayed to the user using LED as a function of values of the model.

5. The device according to claim 1, wherein an end of usability can be displayed in accordance with a calculated model value, said calculated model value being derived from an integrating model (199).

5a. (canceled)

6. The device according to claim 1, wherein the model values and the threshold values are displayed on an external device via radio communication if the device is extended by a radio communication unit.

7. The device according to claim 1, which starts to calculate and signal the life-cycle model when a temperature falls below a certain value.

8. The device according to claim 1, which is protected from damage due to thawing by varnishing or encapsulation.

9. The device according to claim 1, wherein the power source is a lithium primary battery.

10. The device according to claim 1, wherein the temperature (Tₚ) of the product to be monitored is or can be modeled by at least one dynamic delay (12, 15), and an admissible life cycle is calculated by an integrator (11, 14).

11. The device according to claim 1, comprising an integrator (14) that is capable of determining an allowed processing time as a function of temperature variations.

11a. (canceled)

12. The device according to claim 1, having a further function (15) for considering nonlinear processes as a function of the temperature difference to a target value (16) of the product to be monitored.

13. The device according to claim 1, wherein the model is dependent on the temperature of the product to be monitored.

14. The device according to claim 1, wherein the target value (16) represents the temperature at which a permanent safe storage value and/or transport value is given.

14a. (canceled)

15. The device according to claim 1, comprising a temperature sensor (10) for detecting a temperature (T_{P}) of the product to be monitored.

16. The device according to claim 1, comprising a delay model having functional elements (11, 12) for forming a value, e.g. a difference value between the measured temperature and the real temperature of the product to be monitored.

17. The device according to claim 1, comprising a nonlinear gain (12) for modeling phase transitions of the product to be monitored, e.g. its freezing point.

18. The device according to claim 1, comprising a nonlinear limitation (13) as a further function.

19. The device according to previous claim 18, wherein the nonlinear limitation (13) is formed in order to distinguish irreversible processes from reversible processes.

20. (canceled)

21. (canceled)

22. The device according to claim 5, wherein an end of usability can be displayed in accordance with a calculated model value.

23. The device according to claim 3, wherein the state of the safe transfer of perils from a carrier to a user is indicated by a flashing green display.

24. The device according to claim 1, wherein the temperature sensor is integrated in the chip.

25. A method for signaling a state of a product to be monitored having a specific requirement to its temperature at least upon delivery or administration thereof or both,
using a miniaturized device comprising, integrated in a chip, a temperature sensor and a microcomputer supplied with power from a power source, and comprising a display unit,
wherein the microcomputer calculates a thermal model of a state, which thermal model is dependent on the temperature of the product to be monitored, and wherein the state is signaled as a function of state values of the model.

26. The device according to claim 11, comprising the integrator (14) that is capable of determining the allowed processing time as a function of temperature variations in order to display the result of the integrator using at least one threshold value or to start further processes for processing the product to be monitored.

27. The device according to claim 14, wherein the target value (16) represents the temperature at which a permanent safe storage value or transport value is ensured.

28. The method according to claim 25, wherein the product to be monitored is a vaccine, a foodstuff or a biochemical good.
